(19) United States
(12) Patent Application Publication
(10) Pub. No.: US 2016/0227797 A1
(43) Pub. Date: Aug. 11, 2016

(54) REDUCING MICROORGANISMS IN HIGH PRESSURE PROCESSED FOODS

(71) Applicant: WTI, Inc., Jefferson, GA (US)

(72) Inventors: Jasdeep K. Saini, Jefferson, GA (US); Kevon Ledgerwood, Jefferson, GA (US); James L. Marsden, Jefferson, GA (US); Wolfgang Ludwig, Jefferson, GA (US)

(21) Appl. No.: 15/017,009

(22) Filed: Feb. 5, 2016

Related U.S. Application Data
(60) Provisional application No. 62/112,322, filed on Feb. 5, 2015.

(51) Int. Cl. A23B 4/12; A23L 3/015

(52) U.S. Cl. CPC A23B 4/12; A23L 3/0155; A23L 1/315; A23V 2002/00

(57) ABSTRACT

Methods of high pressure processing of food products are provided. The methods can include adding a secondary inhibitor to the food product to prevent or slow the growth of pathogenic microorganisms and/or to prevent or slow the growth of spoilage microorganisms. The methods can increase the shelf life and/or the usable life of ready-to-eat food products. Exemplary food products include ready-to-eat deli style meats such as beef, turkey, or ham products. The secondary inhibitor can be an organic acid or consumable salt thereof. In some embodiments the secondary inhibitor is acetic acid, e.g. vinegar. High pressure processed food products are also provided. The food products can have a longer shelf life, a longer usable life, and can be safer for human consumption that conventional high pressure processed food products.

This application claims priority to co-pending U.S. provisional application entitled “REDUCING MICROORGANISMS IN HIGH PRESSURE PROCESSED FOODS” having Ser. No. 62/112,322, filed Feb. 5, 2015, which is hereby incorporated by reference in its entirety.

### FIELD OF THE DISCLOSURE

The disclosure is generally in the field of high pressure processed, ready-to-eat foods and methods of preparation thereof.

### BACKGROUND OF THE DISCLOSURE

Food-borne diseases are an increasing matter of concern. Recent estimates suggest that about 76 million cases of food-borne illnesses occur annually in the United States alone. 5000 are reported to result in death. Microorganisms are the main agents responsible for food spoilage and food poisoning and therefore food preservation procedures are targeted towards them.

Listeria monocytogenes has unique survival and propagation properties among food pathogens. Unlike other bacterial pathogens such as Salmonella, E. coli, or Campylobacter, Listeria monocytogenes can grow robustly at refrigeration temperatures of 4° C. or less. Ergo, refrigeration is not a significant obstacle to this pathogen. This means that a small amount of contamination on a food product can grow to dangerous levels even under proper refrigeration and handling conditions. Listeria monocytogenes can also form resistant biofilms on foods and other surfaces, which are difficult to eradicate using normal cleaning and disinfection processes and chemicals. Finally, Listeria monocytogenes as a species represents a wide range of serovars, subspecies, and adaptive physiologies ideal for survival and growth in a wide range of habitats and conditions. Listeria are often found in a wide range of food processing plants, kitchens, and delis, and in a wide range of retail foods, from fresh cantaloupes, lettuce, and cabbage to processed lunchmeats, ready-to-eat deli salads, cheeses, to name just a few.

Food preservation methods currently used by the industry rely either on the inhibition of microbial growth or on microbial inactivation. Examples of procedures to preserve foods are drying, salting, thermal treatment and fermentation. Thermal treatment is the most widely used procedure. However, heat can trigger unwanted reactions, leading to undesirable organoleptic and nutritional effects. This limitation with increasing consumer demand for fresh-like foods has promoted the development of alternative methods for food preservation. High pressure processing (HPP) has revolutionized food preservation methods. Utilizing high pressure, HPP allows the food to retain its vitamins, nutritional value, texture, and taste, unlike traditional pasteurization processes that require heat. High pressure processing is also referred to as high hydrostatic pressure, ultra-high pressure processing, or Pascalization.

High pressure processing of food products occurs as a part of the manufacturing process of several ready-to-eat, deli-style meat and poultry products. Ready-to-eat (RTE), deli-style food products are currently being processed using a high pressure processing method. The most commonly used parameters are 87000 psi for 3 min. HPP inactivates pathogenic microorganisms and also reduces the level of spoilage organisms significantly. However, when product is opened for slicing re-contamination can occur with pathogen Listeria monocytogenes and spoilage microorganisms. The exposed surface area of the product is increased due to slicing hence making the product more susceptible to spoilage and reducing shelf-life. The USDA Food Safety and Inspection Service (FSIS), Docket No. FSIS-2013-0038 indicates slicers in retail delis as the key sources of cross-contamination.

An object of the present disclosure is to provide methods capable of extending the shelf life and/or the usable life of high pressure processed food products, especially ready-to-eat food products.

A further object of the disclosure is to provide methods of reducing the growth rate and/or the levels of spoilage microorganisms in high pressure processed food products.

It is also an object of this disclosure to provide high pressure processed food products with increased usage life as compared to conventional high pressure processed food products.

### SUMMARY

Methods of high-pressure processing of a food product are provided. The methods can include adding an effective amount of a secondary inhibitor to the food product. The methods can further include sealing the food product comprising the secondary inhibitor in a vacuum sealed package; placing the vacuum sealed package into a pressure vessel comprising a pressure medium; and pressurizing the pressure vessel to a predetermined pressure for a period of time. Suitable pressures can include from about 60,000 psi to about 100,000 psi, although higher and lower pressures can be used in some embodiments. Suitable periods of time can be determined, but in some instances the period of time is from about 100 s to about 400 s. The pressure medium can be air, water, or oil.

Methods of high-pressure processing of ready-to-eat food products are provided. The food product can be ready-to-eat beef, ready-to-eat poultry, ready-to-eat pork, or ready-to-eat fish. The ready-to-eat food product can be prepared by any of the methods of high-pressure processing provided herein. The food product can have a longer usable life than the same food product under the otherwise same conditions except not prepared with high pressure processing. The food product can have a longer usable life than the same food product under the otherwise same conditions except not prepared with a secondary inhibitor. In some embodiments, the food product has a lower level of pathogenic microorganisms after storage at 39±1° F. for 21 days than the same food product under the otherwise same conditions except for without the secondary inhibitor or without the high pressure processing.

Many suitable secondary inhibitors are provided herein. The secondary inhibitor can be an organic acid or a consumable salt thereof. The organic acid can be acetic acid, propionic acid, levulinic acid, citric acid, lactic acid, malic acid, gluconic acid, tartaric acid, fumaric acid, adipic acid, succinic acid, ascorbic acid, phosphoric acid, or a combination thereof. In some instances the secondary inhibitor is vinegar. The secondary inhibitor can be present at any effective amount. The effective amount can be from about 0.1% DV to about 0.5% DV, or from about 0.1% to about 1.5% (w/w) based upon the weight of the food product. In some embodiments the effective amount is effective to slow the growth of Listeria monocytogenes by at least 50% as compared to the same food product under the otherwise same conditions except without the secondary inhibitor. The effective amount can be effective to prevent the outgrowth of Listeria monocytogenes to ≦2 log cfu/g.

In some embodiments the secondary inhibitor and the high-pressure processing have a synergistic effect. For example, the effective amount can be at least 50% less than the effective amount of the secondary inhibitor that would be needed to achieve the same usable life in the same food product under the same conditions except without the high pressure processing. In some embodiments the percent increase in usable life of the food product is greater than the possible percent increase in usable life of the otherwise same food product except using only the secondary inhibitor or the high pressure processing. For example, the food product can have a lower level of pathogenic microorganisms after storage at 39±1° F. for 21 days than the same food product under the otherwise same conditions except for without the secondary inhibitor or without the high pressure processing. For example, the food product can have a lower level of pathogenic microorganisms after storage at 39±1° F. for 21 days than the same food product under the otherwise same conditions except for without the secondary inhibitor or without the high pressure processing.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1 is a graph of the enumeration of Listeria monocytogenes in Log CFU/g along the vertical axis as a function of the number of days post inoculation for sliced turkey samples inoculated with 3 Log CFU/g Listeria monocytogenes and stored at 40±1° F. in heat sealed bags with stacked slices.

FIG. 2 is a graph of the enumeration of Listeria monocytogenes in Log CFU/g along the vertical axis as a function of the number of days post inoculation for sliced roast beef samples inoculated with 3 Log CFU/g Listeria monocytogenes and stored at 40±1° F. in heat sealed bags with stacked slices.

FIG. 3 is a graph of the enumeration of Listeria monocytogenes in Log CFU/g along the vertical axis as a function of the number of days post inoculation for sliced ham samples inoculated with 3 Log CFU/g Listeria monocytogenes and stored at 40±1° F. in heat sealed bags with stacked slices.

### DETAILED DESCRIPTION

Described below are various embodiments of the present disclosure. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described, there is no intent to limit it to the embodiment or embodiments disclosed herein. On the contrary, the intent is to cover all alternatives, modifications and equivalents included within the spirit and scope of the disclosure.

### I. DISCUSSION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible

Embodiments of the present disclosure will employ, unless otherwise indicated, techniques of chemistry, synthetic inorganic chemistry, analytical chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in psi. Standard temperature and pressure are defined as 0° C. and 1 bar.

It is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### II. DEFINITIONS

Unless defined otherwise, all technical and scientific terms used herein have the same meaning as commonly understood by one of ordinary skill in the art to which this disclosure pertains.

The term “food products”, as used herein, is to be understood in a broad sense and includes meat products, fish products, dairy products, beverage products, baking products, unpasteurized food products, salads, and sauces, marinades, salsas and seasonings. In some embodiments, the food product contains one or more meat products such as beef, pork, poultry, or fish. The food products can be ready-to-eat food products. The term “ready-to-eat” means the food product is distributed to be consumed without further preparation by the consumer or distributed to not require cooking or preparation to achieve food safety prior to consumption.

The term “meat product”, as used herein, includes any food product that primarily contains animal tissue, e.g. contains at least 70%, at least 80%, at least 90%, or at least 95% animal tissue including, but not limited to, beef, pork, poultry, and fish. Other animal tissues can include the tissue of many ungulates that can be used for human consumption such as deer, oxen, antelope, sheep, and goat. The term “meat product” as used herein encompasses processed meats (such as sausages, hamburgers, luncheon meats and cold cuts) and pre-prepared meat dishes such as meat pies, fish pies, game pies, stews, lasagnas and other meat-containing pasta dishes, chicken kiev, chicken cordon-bleu, chicken-a-la-king, meat rolls, meatloaf, pates, sushi, sashimi, salmon mousses, fishcakes, stir-fries etc. The term “ready-to-eat meat product” should include any meat product, which is distributed to be consumed without further preparation by the consumer or distributed to not require cooking prior to consumption. Ready-to-eat meat products include, but are not limited to, pates, hot dogs, bologna, ham, salami, sausages, deli meats, cold cuts, and dried or cured meat products. Ready-to-eat meat products can include ready-to-eat beef products, ready-to-eat pork products, ready-to-eat poultry products, and ready-to-eat fish products.

The term “beef product”, as used herein, refers to any food that primarily contains cow tissue, e.g. contains at least 70%, at least 80%, at least 90%, or at least 95% cow tissue. The term “cow” refers to any animal of the genus Bos, such as for example the Bos Taurus, which is used as a food source for human consumption. Exemplary cow breeds used as commercial livestock include the Holstein, Ayrshire, Angus, and Limousin.

The term “poultry product”, as used herein, refers to any food that primarily contains poultry tissue, e.g. contains at least 70%, at least 80%, at least 90%, or at least 95% poultry tissue. The term “poultry” refers to any edible birds such as chickens, turkeys, ducks, geese, and squab. Poultry can include animals of the genus Gallus, for example the Gallus gallus domesticus, which is used as a food source for human consumption. Poultry can include animals of the genus Meleagris, for example the Meleagris gallopavo, which is used as a food source for human consumption.

The term “pork product”, as used herein, refers to any food product that primarily contains pig tissue, e.g. contains at least 70%, at least 80%, at least 90%, or at least 95% pig tissue. The term “pig” refers to any animal of the genus Sus, such as for example Sus Scrofa, which is used as a food source for human consumption. Exemplary pig breeds used as commercial livestock include Berkshire, Large White, Duroc, Hampshire, Landrace, Meishan, Pietrain, and many others.

As used herein, the term “fish product” should include any food product that primarily contains tissue from an aquatic animal, e.g. contains at least 70%, at least 80%, at least 90%, or at least 95% tissue from an aquatic animal. Aquatic animals can include lobster, crab, fresh water fish, smoked salmon, smoked other fish, salted fish, saltwater fish and other seafood.

As used herein, the term “dairy product” should include any food product made using milk or milk products, including, but not limited to, milk, yogurt, ice cream, cheese, skimmed milk, acidified milk, butter milk, condensed milk, spreads, margarines, milk powder, butter, EMC (Enzyme Modified Cheese), dulche de leche, coffee whitener; coffee creamer, cream, sour cream, ghee, and dairy analogue. Cheese may be any cheese, e.g. fresh cheese, hard cheese, curd cheese, cream cheese, white mould cheese, blue mould cheese and process cheese.

As used herein, the term “unpasteurized food product” should include any food product, whereby at least one ingredient is unpasteurized and which undergoes no final heat treatment.

The term “high pressure processing”, as used herein with respect to food products, refers to any of several methods known in the art for subjecting a food product to a pressure above atmospheric pressure for a period of time to eliminate microorganisms and extend the shelf life of the food product. The pressure can be any pressure sufficient to kill a substantial portion of the microorganisms, for example, about 20,000 psi to about 200,000 psi, about 40,000 psi to about 200,000 psi, about 40,000 psi to about 150,000 psi, about 60,000 psi to about 120,000 psi, about 60,000 psi to about 100,000 psi, or about 80,000 psi to about 100,000 psi. The time can be any time. For example the time can be about 10 s to about 1,000 s, about 50 s to about 800 s, about 100 s to about 600 s, or about 100 s to about 400 s.

As used herein, an “effective amount” is at least the minimum concentration required to have a measurable decrease in the growth rate of one of more microorganisms or a measurable decrease in the amount of one or more microorganisms. An effective amount can substantially prevent the growth of one or more microorganisms for a period of time up to about 5 days, 7 days, 10 days, 14 days, 21 days, 25 days, 30 days, or 45 days. A secondary inhibitor is said to substantially prevent the growth of one or more microorganisms when the secondary inhibitor reduces the rate of growth of one or more microorganisms by at least 10%, at least 20%, at least 30%, at least 40%, at least 50%, at least 60%, at least 70%, at least 80%, at least 90%, at least 95%, or at least 99% at 39±1° F. as compared to the same sample under the same conditions except without the secondary inhibitor. Substantially preventing the growth of one or more microorganisms can include reducing the amount of the microorganism present after 3, 7, 9, 11, 14, 30, 60, 90, or 120 days or longer at 39±1° F. as compared to the level of the microorganism present after the same time in otherwise the same sample except without the secondary inhibitor. Substantially preventing the growth of one or more microorganisms can include completely eliminating the growth of the microorganism, reducing the amount of the microorganism, or completely eliminating the microorganism after a period of about 3, 7, 9, 11, 14, 30, 60, 90, or 120 days or longer at 39±1° F. According to Food and Drug Administration United States Public Health Service 2013 Food Code, the refrigerated shelf-life at retail counter should not exceed and 30 days and food items should be discarded after that. Additionally, deli-sliced RTE products should be held at 41° F. or below for no more than 7 days once the package is opened for slicing.

The term “daily value”, as used herein, can be given the meaning supplied by the United States Food and Drug Administration (U.S. F.D.A.), for example as described in the “Guidance for Industry: A Food Labeling Guide” published by the Office of Nutrition, Labeling, and Dietary Supplements of the U.S. F.D.A., last revised January 2013. There are two sets of reference values for reporting nutrients in nutrition labeling: 1) Daily Reference Values (DRVs) and 2) Reference Daily Intakes (RDIs). These values assist consumers in interpreting information about the amount of a nutrient present in a food and in comparing nutritional values of food products. DRVs are provided for total fat, saturated fat, cholesterol, total carbohydrate, dietary fiber, sodium, potassium, and protein. RDIs are provided for vitamins and minerals and for protein for children less than four years of age and for pregnant and lactating women. To limit consumer confusion, the single term “daily value”, often denoted as “DV”, is used to designate both the DRVs and RDIs. For substances where no RDI or DRV has been established, the DV can be taken, for example, as the average daily intake of the substance based on food intake concentrations for persons over 2 years old on a standard 2,000-calorie diet.

The term “consumable salt”, as used herein, refers to derivatives of a compound, wherein the parent compound is modified by making acid or base salts thereof which are, within the scope of sound scientific judgment, suitable for consumption by human beings and animals without excessive toxicity, irritation, allergic response, or other problems or complications commensurate with a reasonable benefit/risk ratio. Example of consumable salts include but are not limited to mineral or organic acid salts of basic residues such as amines; and alkali or organic salts of acidic residues such as carboxylic acids. The consumable salts include the conventional non-toxic salts or the quaternary ammonium salts of the parent compound formed, for example, from non-toxic inorganic or organic acids. Such conventional non-toxic salts include those derived from inorganic acids such as hydrochloric, hydrobromic, sulfuric, sulfamic, phosphoric, and nitric acids; and the salts prepared from organic acids such as acetic, propionic, succinic, glycolic, stearic, lactic, malic, tartaric, citric, ascorbic, pamoic, maleic, hydroxymaleic, phenylacetic, glutamic, benzoic, salicylic, sulfanilic, 2-acetoxybenzoic, fumaric, tolunesulfonic, naphthalenesulfonic, methanesulfonic, ethane disulfonic, oxalic, and isethionic salts.

The consumable salts of the compounds can be synthesized from the parent compound, which contains a basic or acidic moiety, by conventional chemical methods. Such salts can be prepared by reacting the free acid or base forms of these compounds with a stoichiometric amount of the appropriate base or acid in water or in an organic solvent, or in a mixture of the two; generally, non-aqueous media like ether, ethyl acetate, ethanol, isopropanol, or acetonitrile are preferred. Lists of suitable salts can be found in Remington's Pharmaceutical Sciences, 20th ed., Lippincott Williams & Wilkins, Baltimore, Md., 2000, p. 704; and “Handbook of Pharmaceutical Salts: Properties, Selection, and Use,” P. Heinrich Stahl and Camille G. Wermuth, Eds., Wiley-VCH, Weinheim, 2002.

The term “generally recognized as safe” or “GRAS”, as used herein, refers to substances generally recognized, among qualified experts, as having been adequately shown to be safe under the conditions of its intended use, for example by general recognition of safety through scientific procedures under 21 C.F.R §170.30(b) or by general recognition of safety through experience based on common use in foods by a substantial history of consumption for food use under 21 C.F.R §170.30(c). GRAS substances can include those substances listed in 21 C.F.R. §182.

The term “safe”, as used herein with reference to food, refers to a state wherein the food is sufficiently free of pathogenic micro-organisms or the toxic products of microbial growth to be fit for human or animal consumption.

As used herein, the term “shelf life” refers to the period of time that a food product remains saleable to retail customers and remains fit and safe for use or consumption. Changes including, but not limited to, oxidation, odor development, discoloration in addition to microbial changes can alter the shelf life of the food product. In traditional meat processing, the shelf life of fresh meat and meat by-products is about 30 to 40 days after an animal has been slaughtered. Refrigeration of meat during this period of time largely arrests and/or retards the growth of micro-organisms. After about 30 to 40 days, however, refrigeration can no longer effectively control the proliferation of micro-organisms. Micro-organisms present on meat products after this time period may have proliferated to a great extent and/or have generated unacceptable levels of undesirable by-products. Spoilage micro-organisms may also act to discolor meat, making such meat unappealing and undesirable for human consumption. Pathogenic micro-organisms may have proliferated in this time period to a level wherein they can cause disease in an animal that consumes the food product.

As used herein, the term “usable life” refers to the period of time that a high-pressure processed food product remains fit for human consumption, e.g. safe and substantially free of food spoilage, after having been removed from the original packaging. For example, deli-style ready-to-eat meat products may be opened and sliced at the deli counter. The unsliced meat at the deli counter will have a usable life different from the sliced deli meat. The usable life will depend upon factors such as the storage temperature, the surface area, and the handling conditions.

“Food spoilage”, as used herein, refers to organoleptic changes in the food, i.e. alterations in the condition of food which makes it less palatable, for example, changes in taste, smell, texture or appearance which are related to contamination of the food with one or more spoilage micro-organisms. Spoiled food may or may not be safe for consumption.

“Food preservation”, as used herein, refers to methods which maintain or enhance food safety for example, by controlling the growth and proliferation of pathogenic and spoilage micro-organisms, thus guarding against food poisoning and delaying or preventing food spoilage. Food preservation helps food remain safe for consumption for longer periods of time (i.e. improves the shelf life) and inhibits or prevents nutrient deterioration and/or organoleptic changes which cause food to become less palatable.

The term “micro-organism” as used herein, includes bacteria, fungi and parasites. Non-limiting examples of micro-organisms that can be controlled using the formulations and methods described herein include bacteria from the genus Aeromonas (e.g. A. hydrophilia), Arcobacter, Bacillus (e.g. B. cereus), Brochothrix (e.g. B. thermosphacta), Campylobacter (e.g. C. jejuni), Carnobacterium (e.g. C. piscicola), Chlostridium (e.g. C. perfringens, C botulinum), Enterobacteriacae, Escherichia (e.g. E. coli O157:H7), Listeria (e.g. L. monocytogenes), Pseudomonas (e.g. P. putida, P. fluorescens), Salmonella (e.g. S. Typhimurium), Serratia (e.g. S. liquefaciens), Shigella, Staphylococcus (e.g. S. aureus), Vibrio (e.g. V. parahaemolyticus, V. cholerae) and Yersina (e.g. Y. enterocolitica); fungi such as Aspergillus flavum and Penicillium chrysogenum; parasites such as Amoebiasis (Emoebiasis histolytica), Balantidiosis (Balantidiosis coli), Entamoeba histolytica, Cryptosporidiosis (e.g. Cryptosporidium parvum), Cyclosporidiosis (e.g. Cyclospora cayetanensis), Giardiasis (e.g. Giardia lamblia, Giardia intestinalis), Isosporiasis (Isosporiasis belli), Microsporidiosis (Enterocytozoon bieneusi, S. intestinalis), Trichinella spiralis and Toxoplasma gondii. The term micro-organism also refers to vegetative or dormant forms of bacteria and fungi, such as spores wherein activation of the growth cycle may be controlled using the methods provided herein.

The term “spoilage micro-organism” as used herein refers to a micro-organism that acts to spoil food. Spoilage micro-organisms may grow and proliferate to such a degree that a food product is made unsuitable or undesirable for human or animal consumption. The production of undesirable by-products by the microorganism, such as carbon dioxide, methane, nitrogenous compounds, butyric acid, propionic acid, lactic acid, formic acid, sulphur compounds, and other gases and acids can cause detrimental effects on the foodstuff alteration of the colour of meat surfaces to a brown, grey or green colour, or creation of an undesirable odour. The colour and odour alterations of food products due to the growth of spoilage micro-organisms frequently result in the product becoming unsaleable.

The term “pathogenic micro-organism” as used herein refers to a micro-organism capable of causing disease or illness in an animal or a human, for example, by the production of endotoxins, or by the presence of a threshold level of micro-organisms to cause food poisoning, or other undesirable physiological reactions in humans or animals.

### III. METHODS OF HIGH PRESSURE FOOD PROCESSING

Methods of high pressure processing of food products are provided. The methods can include adding a secondary inhibitor or a consumable salt thereof to the food product during the high pressure processing. The secondary inhibitor or consumable salt thereof can be added at an effective amount, e.g. an effective amount to increase the shelf life of, prevent the spoilage of, or decrease the growth rate of one or more microorganisms in the food products.

Methods of high pressure processing are known in the art. The methods can include sealing the food product having a secondary inhibitor or consumable salt thereof in a vacuum-sealed package; placing the vacuum-sealed package into a pressure vessel containing a pressure medium; and pressurizing the pressure vessel to a predetermined pressure for a period of time. The predetermined pressure can be any pressure sufficient to render the food product safe, e.g. to substantially kill all pathogenic microorganisms or spoilage microorganisms. For example, the predetermined pressure can be from about 50,000 psi to about 500,000 psi, from about 50,000 psi to about 250,000 psi, from about 60,000 psi to about 250,000 psi, from about 70,000 psi to about 250,000 psi, from about 80,000 psi to about 250,000 psi, from about 80,000 psi to about 200,000 psi, or from about 80,000 psi to about 100,000 psi. The predetermined pressure can be up to about 50,000 psi, up to about 60,000 psi, up to about 70,000 psi, up to about 80,000 psi, up to about 90,000 psi, up to about 100,000 psi, or about 87,000 psi. Although any period of time that renders the food product safe is acceptable, in some embodiments the period of time is about 10 s to 5,000 s, about 20 s to about 4,000 s, about 30 s to about 2,000 s, about 40 s to about 2,000 s, about 40 s to about 1,000 s, about 50 s to about 500 s, about 50 s to about 400 s, about 50 s to about 300 s, about 50 s to about 200 s, or about 60 s to about 180 s. Suitable pressure mediums for these pressures can include air, water, or oils.

Suitable food products can include any food product prepared by high-pressure processing, especially ready-to-eat food products such as ready-to-eat meat products, deli meats, etc. The food products can be ready-to-eat beef products, ready-to-eat pork products, ready-to-eat poultry products, or ready-to-eat fish products. The food products can be high-pressure processed cheese products. Exemplary food products include deli-style turkey products, deli-style beef products, and deli-style ham products.

The secondary inhibitor is added to the food product to prevent and/or slow the growth of pathogenic microorganisms in, to prevent or slow the growth of spoilage microorganisms in, to increase the safety of, and/or to increase the usable life of high pressure processed food products, especially upon opening of the food product at the point of use or distribution. Suitable secondary inhibitors can include any secondary inhibitor capable of preventing or slowing the growth of one or more pathogenic microorganisms or one or more spoilage microorganisms. The secondary inhibitor can be generally recognized as safe, e.g. can be a substance listed in 21 C.F.R. §182. In some embodiments, the secondary inhibitor is effective at slowing or preventing the growth of Listeria monocytogenes.

The secondary inhibitor can be an edible organic acid or a consumable salt thereof. For example, the secondary inhibitor can be acetic acid, propionic acid, levulinic acid, citric acid, lactic acid, malic acid, gluconic acid, tartaric acid, fumaric acid, adipic acid, succinic acid, ascorbic acid, phosphoric acid, a consumable salt thereof, and a combination thereof. In some embodiments the secondary inhibitor is acetic acid or a consumable salt thereof, e.g. sodium acetate. In some embodiments, the secondary inhibitor is vinegar. The term “vinegar” refers to an acetic acid solution which contains from 1 to 10 percent by weight acetic acid and more commonly about 4 to 8 percent, and which may contain flavor and/or other types of compounds. Examples include glacial vinegar, apple cider vinegar, balsamic vinegar, and the like. Other secondary inhibitors can include acetate, diacetate, citrate, and combinations thereof.

The secondary inhibitor can be added for food preservation. The secondary inhibitor can be added at any amount effective to increase the shelf life of the food product. The secondary inhibitor can be added at any amount effective to increase the usable life of the food product. The secondary inhibitor can be added at any amount effective to prevent or slow the growth of one or more pathogenic microorganisms. The secondary inhibitor can be added at any amount effective to prevent or slow the growth of one or more spoilage microorganisms. The secondary inhibitor can be added at any amount effective to prevent or slow the growth of a microorganism from the genus Listeria, e.g. to reduce the levels of Listeria monocytogenes, to prevent growth of Listeria monocytogenes, or to slow the growth of Listeria monocytogenes by at least 1%, 5%, 10%, 15%, 20%, 25%, 30%, 40%, 50%, 60%, 70%, 80%, 90%, or 95% as compared to the same food product under the otherwise same conditions except without the secondary inhibitor.

The effective amount of the secondary inhibitor can depend upon several factors including the type of food product, the specific secondary inhibitor, the surface area of the food product, the storage conditions, and/or the handling conditions. In some embodiments, the effective amount of a secondary inhibitor is from about 0.05% DV to about 5% DV, from about 0.05% DV to about 1% DV, from about 0.05% DV to about 0.5% DV, from about 0.1% DV to about 0.5% DV, from about 0.2% DV to about 0.5% DV, from about 0.2% DV to about 0.4% DV, or from about 0.2% DV to about 0.3% DV. In some embodiments the secondary inhibitor is acetic acid and the DV is about 2.1 g/day, e.g. about 1.5 g/day to about 3 g/day or about 2.0 g/day to about 2.5 g/day. In some embodiments the secondary inhibitor is sodium acetate and the DV is about 0.23 g/day, e.g. about 0.15 g/day to about 0.3 g/day or about 0.2 g/day to about 0.25 g/day. In some embodiments, the secondary inhibitor is added to the food product at an amount from about 0.01% (w/w) to about 5% (w/w), from about 0.05% (w/w) to about 5% (w/w), from about 0.05% (w/w) to about 4% (w/w), from about 0.05% (w/w) to about 3% (w/w), from about 0.05% (w/w) to about 2.5% (w/w), from about 0.1% (w/w) to about 2.5% (w/w), from about 0.1% (w/w) to about 2% (w/w), from about 0.1% (w/w) to about 1.5% (w/w), from about 0.1% (w/w) to about 1% (w/w), or from about 0.5% (w/w) to about 1% (w/w). The effective amount of the secondary inhibitor, when added in combination with high pressure processing, can be less than the effective amount of the secondary inhibitor in the otherwise same food product under the same conditions except without the high pressure processing.

In some embodiments the secondary inhibitor and the high-pressure processing have a synergistic effect. “Synergism” can mean two or more factors have an effect when combined that is greater than the predicted effect based on the response to each factor applied separately. The synergistic combination of high pressure processing and an effective amount of a secondary inhibitor can mean that the shelf life of the food product is longer than the shelf life that is possible using either high pressure processing or the secondary inhibitor alone. The synergistic combination of high pressure processing and an effective amount of a secondary inhibitor can mean that the usable life of the food product is longer than the usable life that is possible using either high pressure processing or the secondary inhibitor alone. In some embodiments, Colby's formula can be applied to determine when high pressure processing and the secondary inhibitor have a synergistic effect. S. R. Colby, Calculating Synergistic and Antagonistic Responses of Herbicide Combinations, WEEDS 1967, 15, 22:

E=X+Y−100*X*Y,

wherein X is the effect in percent (%) of high pressure processing alone, wherein Y is the effect in percent (%) of the secondary inhibitor alone, and E is the expected effect in percent (%) of the combined use of high pressure processing and the secondary inhibitor added at the same amount. The effect can be the percent reduction in growth rate of one or more pathogenic microorganisms, the percent reduction in growth rate of one or more spoilage microorganisms, the percent increase the shelf life, or the percent increase in usable life as compared to the food product without the high pressure processing and without the secondary inhibitor. The effect can be the percent reduction for a pathogenic microorganism in the food product after a specific time period as compared to the same food product under the otherwise same conditions without the high pressure processing and without the secondary inhibitor. In some embodiments the fractional inhibitory concentration (FIC) index can be applied to determine when high pressure processing and the secondary inhibitor have a synergistic effect.

### IV. HIGH PRESSURE PROCESSED FOODS

High pressure processed food products are provided. The food products can be prepared by any of the methods described herein. The food products can contain any of the secondary inhibitors described herein. The food products can include any food product prepared by high-pressure processing, especially ready-to-eat food products such as ready-to-eat meat products, deli meats, etc. The food products can be ready-to-eat beef products, ready-to-eat pork products, ready-to-eat poultry products, or ready-to-eat fish products. The food products can be high-pressure processed cheese products. Exemplary food products include deli-style turkey products, deli-style beef products, and deli-style ham products.

In some embodiments a food product is provided, wherein the food product has been high pressure processed with an effective amount of a secondary inhibitor in the food product. The high pressure processing can be performed using any of the methods described above. The food products can have a longer shelf life and/or a longer usable life than the same food products not prepared with the high pressure processing and/or not prepared with the effective amount of the secondary inhibitor. The food products can have a lower level of pathogenic microorganisms and/or a lower level of spoilage microorganism than the otherwise same food product under the same conditions except for without the high pressure processing and/or without the secondary inhibitor.

In some embodiments, a food product is provided wherein the food product contains an effective amount of a secondary inhibitor selected from vinegar, acetic acid, or a consumable salt thereof; and the food product has been high pressure processed with the secondary inhibitor.

### EXAMPLES

### Example 1

### Preliminary Testing of Vinegar Usage Levels in Ready-To-Eat Deli Meats

Testing was performed to determine the best usage level of buffered dry vinegar in different RTE food products to control outgrowth of Listeria monocytogenes for 14 days. Samples were not high pressure processed in Example 1. The results are presented in Table 1 for RTE deli style turkey, in Table 2 for RTE deli style pork, and in Table 3 for RTE deli style beef.

TABLE 1
Listeria monocytogenes enumerated in RTE Turkey with dried vinegar in the
formulation at different usage rates for 21 days.

| Vinegar | Listeria monocytogenes in Turkey (Log CFU/g) | | | | | | | |
|---|---|---|---|---|---|---|---|---|
| Concentration | Day 0 | Day 5 | Day 7 | Day 9 | Day 12 | Day 15 | Day 19 | Day 21 |
| Control | 1.83 | 2.66 | 3.26 | 3.75 | 4.04 | 4.58 | 4.69 | 5.66 |
| 0.2% DV | 1.82 | 1.83 | 1.28 | 1.4 | 1.96 | 2.86 | 3.87 | 3.88 |
| 0.3% DV | 1.87 | 1.83 | 1.13 | 1.1 | 1.8 | 2.22 | 2.6 | 2.83 |
| 0.4% DV | 1.85 | 1.4 | 0.9 | 0.9 | 1.68 | 1.6 | 1.68 | 2.27 |

TABLE 2
Listeria monocytogenes enumerated in RTE Pork with dried vinegar in the
formulation at different usage rates for 21 days.

| Vinegar | Listeria monocytogenes in Pork (Log CFU/g) | | | | | | | |
|---|---|---|---|---|---|---|---|---|
| Concentration | Day 0 | Day 5 | Day 7 | Day 9 | Day 12 | Day 15 | Day 19 | Day 21 |
| Control | 1.42 | 1.3 | 1.5 | 1.93 | 2.38 | 3.38 | 4.06 | 4.78 |
| 0.2% DV | 1.27 | 1.07 | 1.07 | 1.8 | 2.35 | 2.47 | 2.83 | 3.28 |
| 0.3% DV | 1.3 | 0.75 | 0.75 | 0.9 | 1.3 | 1.68 | 2.24 | 2.12 |
| 0.4% DV | 1.3 | 0.6 | 0.75 | 0.6 | 1.68 | 1.3 | 1.68 | 1.6 |

TABLE 3
Listeria monocytogenes enumerated in RTE Beef with dried vinegar in the formulation
at different usage rates for 21 days.

| Vinegar | Listeria monocytogenes in Beef (Log CFU/g) | | | | | | | |
|---|---|---|---|---|---|---|---|---|
| Concentration | Day 0 | Day 5 | Day 7 | Day 9 | Day 12 | Day 15 | Day 19 | Day 21 |
| Control | 1.98 | 1.92 | 2.52 | 3.16 | 3.58 | 4.05 | 4.77 | 5.03 |
| 0.2% DV | 1.87 | 1.9 | 1.89 | 2.8 | 3.07 | 2.56 | 3.7 | 3.89 |
| 0.3% DV | 1.84 | 1.68 | 1.4 | 1.4 | 2.22 | 2.1 | 2.03 | 2.44 |
| 0.4% DV | 1.87 | 1.77 | 1.05 | 1.3 | 1.3 | 1.3 | 1.68 | 1.69 |

### Example 2

### Combined Use of Secondary Inhibitor and High Pressure Processing

Based on the preliminary testing in Example 1, 0.25% vinegar usage rate was chosen to test the products in combination with High Pressure Processing. The control included no antimicrobial under the same high pressure processing conditions. The samples were high pressure processed at 87,000 psi for 180 s.

Samples were prepared as 5 lb chubs with 0.25% buffered dried vinegar in the formulation of RTE deli style turkey, ham and beef. These were then fully cooked and sent to an HPP facility for processing. After HPP, samples were held at refrigerated storage conditions for 30 days and then individually sliced for surface inoculation with a five-strain cocktail of Listeria monocytogenes targeted at 3 Log CFU/g. These samples were then held at 39±1° F. in heat sealed bags with stacked slices. Uninoculated samples were used for shelf-life testing.

Inoculated samples were enumerated for Listeria monocytogenes on modified oxford medium (MOX) and uninoculated samples were enumerated for total aerobic bacteria and lactic acid bacteria on tryptic soy agar (TSA) and de man rogosa sharpe (MRS) agar, respectively. Sampling was performed at Day 0, 3, 7, 9, 11 and 14 days after inoculation. Three replicates of the test were performed (R1-R3)

Results are presented in Table 4 for RTE Turkey, Table 5 for RTE beef, and Table 6 for RTE ham.

TABLE 4
Listeria monocytogenes in RTE turkey with 0.25% DV and
high pressure treated and held at 39 ± 1 F. for 14 days.

| | Log CFU/g | | | | | |
|---|---|---|---|---|---|---|
| | Day 0 | Day 3 | Day 7 | Day 9 | Day 11 | Day 14 |
| Turkey R1 | 3.14 | 3.12 | 3.57 | 4.35 | 4.8 | 5.66 |
| Turkey R2 | 3.12 | 3.11 | 3.59 | 4.3 | 4.68 | 5.42 |
| Turkey R3 | 3.08 | 2.93 | 3.44 | 4.29 | 4.53 | 5.48 |
| Control | 3.2 | 3.69 | >6 | >6 | STOPPED | STOPPED |
| Turkey R1 | | | | | | |
| Control | 3.34 | 4.08 | >6 | >6 | STOPPED | STOPPED |
| Turkey R2 | | | | | | |
| Control | 3.32 | 4.2 | >6 | >6 | STOPPED | STOPPED |
| Turkey R3 | | | | | | |

TABLE 5
Listeria monocytogenes in RTE beef with 0.25% DV and
high pressure treated and held at 39 ± 1 F. for 14 days.

| | Log CFU/g | | | | | |
|---|---|---|---|---|---|---|
| | Day 0 | Day 3 | Day 7 | Day 9 | Day 11 | Day 14 |
| Beef R1 | 3.16 | 3.11 | 3.35 | 4.04 | 4.28 | 5.19 |
| Beef R2 | 3.13 | 3.11 | 3.53 | 4.2 | 4.64 | 5.09 |
| Beef R3 | 3.11 | 3.2 | 3.34 | 3.96 | 4.23 | 4.53 |
| Control | 3.08 | 4.22 | >6 | >6 | STOPPED | STOPPED |
| Beef R1 | | | | | | |
| Control | 3.08 | 3.76 | >6 | >6 | STOPPED | STOPPED |
| Beef R2 | | | | | | |
| Control | 3.08 | 4.27 | >6 | >6 | STOPPED | STOPPED |
| Beef R3 | | | | | | |

TABLE 6
Listeria monocytogenes in RTE ham with 0.25% DV and
high pressure treated and held at 39 ± 1 F. for 14 days.

| | Log CFU/g | | | | | |
|---|---|---|---|---|---|---|
| | Day 0 | Day 3 | Day 7 | Day 9 | Day 11 | Day 14 |
| Ham R1 | 3.16 | 3 | 3.43 | 3.19 | 3.43 | 4.1 |
| Ham R2 | 2.97 | 2.85 | 3.03 | 3.25 | 3.18 | 4.18 |
| Ham R3 | 3.2 | 2.92 | 2.94 | 3.18 | 3.1 | 4.19 |
| Control Ham | 3.25 | 3.15 | 4.19 | 4.44 | 5.06 | >6 |
| R1 | | | | | | |
| Control Ham | 3.12 | 3.22 | 4.14 | 4.92 | 5.57 | >6 |
| R2 | | | | | | |
| Control Ham | 3 | 3.11 | 4.1 | 5.13 | 5.33 | >6 |
| R3 | | | | | | |

### Example 3

### Combined Use of Secondary Inhibitor and High Pressure Processing to Control Listeria Monocytogenes After Opening HPP RTE Sliced Deli Products

Samples were prepared in 5 lb. chubs with secondary inhibitor. Samples without a secondary inhibitor were prepared as a control. The samples were fully cooked and high pressure processed at 87,000 psi for 180 s. After high pressure processing, samples were held at refrigerated storage conditions for 30 days and then individually sliced for surface inoculation with a five-strain cocktail of Listeria monocytogenes targeted at 3 Log CFU/g. These samples were then held at 40±1° F. in heat sealed bags with stacked slices. The inoculated samples were enumerated for Listeria monocytogenes on modified oxford medium (MOX). Sampling was performed at days 0, 3, 5, 7, 10, 12, and 15 after initial inoculation.

The secondary inhibitors used include 0.17% DV™ (a dried vinegar), 0.5% VK™ (a buffered liquid vinegar or acetate), 0.7% IONAL LC™ (a buffered sodium citrate and sodium diacetate blend; see, e.g. U.S. Pat. No. 5,302,406, No. 5,972,398 and No. 7,311,934, all of which are incorporated by reference as if fully set forth herein), 0.25% MARINAL PROTEK™ (a blend of functional organic salts, such as a sodium acetate, diacetate and salt blend), and 1.25% NATUREIN LV1™ (a buffered vinegar and lemon juice concentrate blend), all products of and available from WTI, Inc., Jefferson, Ga. DV™ is a vinegar-derived acetate salt that can be in a powder form or in solution with vinegar. In various aspects, it can have a pH of about 5.0 to a pH of about 10.0.

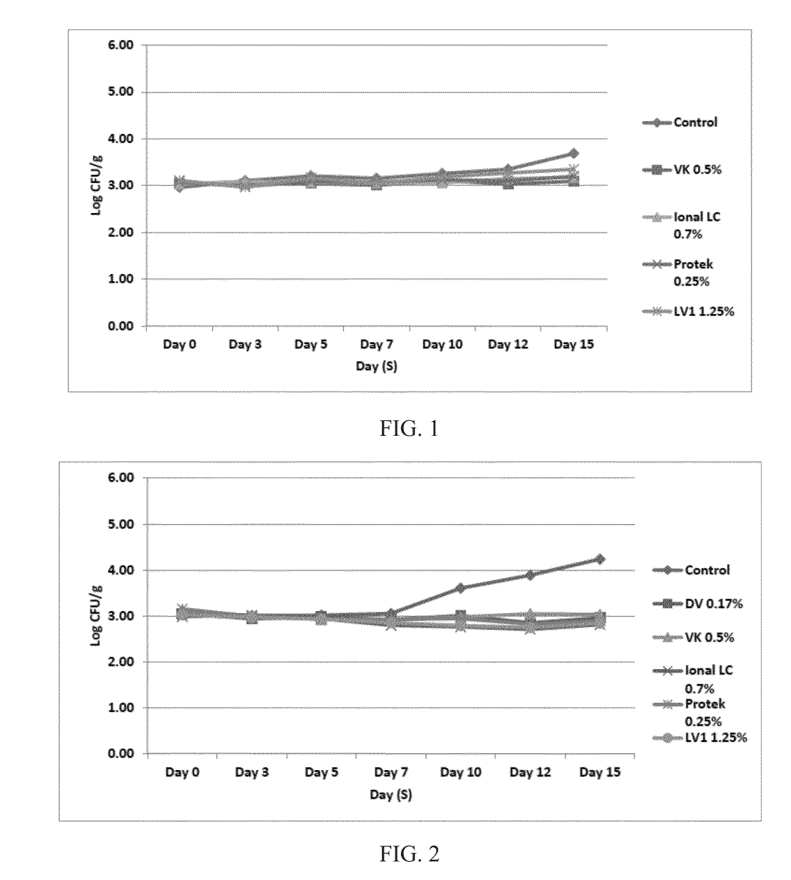

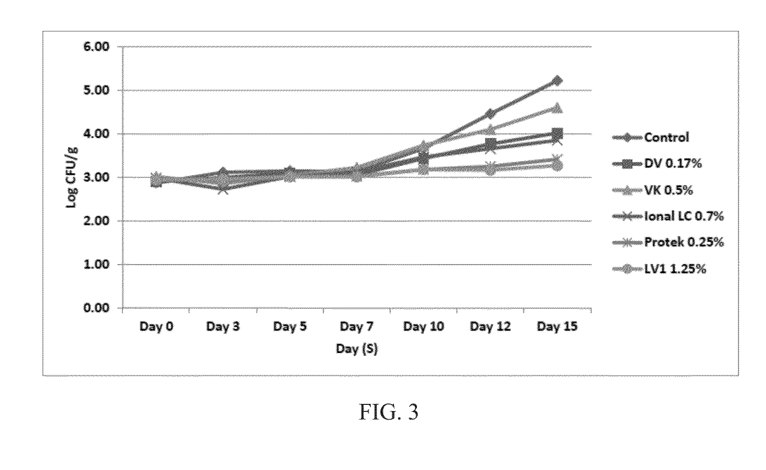

The results are plotted in FIG. 1 for inoculated sliced turkey samples, FIG. 2 for inoculated sliced roast beef samples, and FIG. 3 for inoculated sliced ham samples. The results indicated the significance of using a secondary inhibitor in the formulation of HPP deli products for improved safety and to prevent outgrowth of pathogenic bacteria due to cross contamination upon opening. Samples with secondary inhibitors demonstrated less than 4 Log CFU/g outgrowth after inoculation with 3 Log CFU/g Listeria monocytogenes and storage at 40±1° F. in heat sealed bags for 15 days. Thus, the results indicate improved safety of high pressure processing (HPP) products with the use of the present secondary inhibitors once the HPP packages are opened and product, for example a meat product, is sliced.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

We claim:

1. A method of high-pressure processing of a food product comprising adding an effective amount of a secondary inhibitor to the food product.

2. The method of claim 1, further comprising:
(a) sealing the food product comprising the secondary inhibitor in a vacuum sealed package;
(b) placing the vacuum sealed package into a pressure vessel comprising a pressure medium;
(c) pressurizing the pressure vessel to a predetermined pressure for a period of time.

3. The method of claim 2, wherein the predetermined pressure is from about 60,000 psi to about 100,000 psi.

4. The method of claim 2, wherein the period of time is from about 100 s to about 400 s.

5. The method of claim 3, wherein the period of time is from about 100 s to about 400 s.

6. The method of claim 2, wherein the pressure medium is selected from the group consisting of air, water, and oil.

7. The method of claim 1, wherein the food product is a ready-to-eat food product.

8. The method of claim 2, wherein the food product is a ready-to-eat food product.

9. The method of claim 2, wherein the secondary inhibitor is an organic acid or a consumable salt thereof.

10. The method of claim 8, wherein the organic acid is selected from the group consisting of acetic acid, propionic acid, levulinic acid, citric acid, lactic acid, malic acid, gluconic acid, tartaric acid, fumaric acid, adipic acid, succinic acid, ascorbic acid, phosphoric acid, and a combination thereof.

11. The method of claim 2, wherein the secondary inhibitor is vinegar.

12. The method of claim 1, wherein the effective amount is from about 0.1% daily value (DV) to about 0.5% daily value (DV).

13. The method of claim 1, wherein the effective amount is from about 0.1% to about 1.5% (w/w) based upon the weight of the food product.

14. The method of claim 1, wherein the effective amount is effective to slow the growth of Listeria monocytogenes by at least 50% as compared to the same food product under the otherwise same conditions except without the secondary inhibitor.

15. The method of claim 1, wherein the effective amount is effective to prevent the outgrowth of Listeria monocytogenes to ≦2 log cfu/g.

16. The method of claim 1, wherein the effective amount is at least 50% less than the effective amount of the secondary inhibitor that would be needed to achieve the same usable life in the same food product under the same conditions except without the high pressure processing.

17. The method of claim 1, wherein the percent increase in usable life of the food product is greater than the possible percent increase in usable life of the otherwise same food product except using only the secondary inhibitor or the high pressure processing.

18. A ready-to-eat food product, wherein the ready-to-eat food product has been prepared by the method of claim 2.

19. The ready-to-eat food product of claim 17, wherein the food product is selected from the group consisting of ready-to-eat beef, ready-to-eat poultry, ready-to-eat pork, and ready-to-eat fish.

20. The ready-to-eat food product of claim 18, wherein the food product has a longer usable life than the same food product under the otherwise same conditions except not prepared with high pressure processing.

21. The ready-to-eat food product of claim 18, wherein the food product has a longer usable life than the same food product under the otherwise same conditions except not prepared with a secondary inhibitor.

22. The ready-to-eat food product of claims 18, wherein the food product has a lower level of pathogenic microorganisms after storage at 39±1° F. for 21 days than the same food product under the otherwise same conditions except for without the secondary inhibitor or without the high pressure processing.
